(19) United States
(12) Patent Application Publication
(10) Pub. No.: US 2016/0291634 A1
(43) Pub. Date: Oct. 6, 2016

(54) DATA BANDWIDTH SCALABLE MEMORY SYSTEM

(71) Applicant: QUALCOMM Incorporated, San Diego, CA (US)

(72) Inventors: Jungwon SUH, San Diego, CA (US); David Ian WEST, San Diego, CA (US); Dexter Tamio CHUN, San Diego, CA (US)

(21) Appl. No.: 14/677,752

(22) Filed: Apr. 2, 2015

(51) Int. Cl. G06F 1/14

(52) U.S. Cl. CPC G06F 1/14

(57) ABSTRACT

A clock is distributed to a processor-side base mode clocked transceiver and to a memory-side base mode clocked transceiver, interfacing respective ends of a data lane between a processor and the memory, for duplex communicating over the data lane. Concurrent with the duplex communicating, a bandwidth mode switches between a base bandwidth mode and a scale-up mode. The scale-up mode enables scale-up clock lines that distribute the clock to a processor-side scale-up transceiver and to a memory-side scale-up transceiver, interfacing respective ends of a scale-up data lane between the processor and the memory, for additional duplex communicating over the scale-up data lane. The base bandwidth mode disables the scale-up clock lines, which disables communicating over the scale-up data lane.

### FIELD OF DISCLOSURE

The present application is generally related to memory and, more particularly, to memory access.

### BACKGROUND

A broad range of digital processor devices can include a processor engine that is provided with a local memory and, for accessing external memory devices, is provided with a processor-side interface to a communication line that extends to an external memory device. The communication line may be a data bus. The external memory device can be provided with a memory-side interface to the communication line. The combination of the processor-side interface, the communication line and the memory-side interface serve as an external memory access system. The external memory access system can be designed to meet a given maximum bandwidth requirement. The specific maximum bandwidth requirement can be determined in part by the application(s) that the processing engine will run.

A digital processor, though, may be within a multi-function device, for example, a personal communication device, that may be required to perform a range of application. As illustration, a conventional “smartphone,” runs a broad range of applications. The range can include, at one end, applications such as phone calls and web browsing that generally have low bandwidth requirements and, at the other end, applications such as gaming and other high-resolution video applications. To meet the high bandwidth requirements of upper end applications, the external memory access system can be designed to operate at very high clock frequencies. However, operating the external memory access at such clock frequencies can consume substantial power. Therefore, continuing operation at high clock frequency during intervals in which low bandwidth applications are run can be a substantial and uneconomical use of power. One known technique directed to reducing such power consumption is termed clock frequency scaling. Conventional clock scaling technique includes selective change, or scaling of system clock rates.

### SUMMARY

This Summary identifies features and aspects of some example aspects, and is not an exclusive or exhaustive description of the disclosed subject matter. Whether features or aspects are included in, or omitted from this Summary is not intended as indicative of relative importance of such features. Additional features and aspects are described, and will become apparent to persons skilled in the art upon reading the following detailed description and viewing the drawings that form a part thereof.

Methods are disclosed that can provide scalable data bandwidth interfacing, and according to various aspects, example operations can include a concurrent clocking of a processor-side clocked transceiver and a memory-side clocked transceiver, interfacing a processor side and a memory side of a base mode data lane, respectively, which extends from a processor to a memory. In other aspect, example operations, while clocking the processor-side clocked transceiver and the memory-side clocked transceiver, can include switching from a base bandwidth mode to a scale-up mode. Operations in the scale-up mode can include, for example, a concurrent clocking of a processor-side scale-up clocked transceiver and a memory-side scale-up clocked transceiver, interfacing a processor side and a memory side of a scale-up data lane, respectively, which may extend from the processor to the memory. In another aspect, example operations in the base bandwidth mode can include disabling a clocking of the processor-side scale-up transceiver, or disabling a clocking of the memory-side scale-up clocked transceiver, or both.

Apparatuses for scalable bandwidth data interface are disclosed, and according to various aspects, example features can include a transceiver clock line, which may be configured to carry a clock, and can include a clocked transceiver, which may be configured to transmit data to and receive data from a data lane, in response to the clock on the transceiver clock line. One or more disclosed scalable bandwidth data interfaces can include a scale-up gated clock driver, which may have an input coupled to the transceiver clock line, and may include a scale-up clock line, coupled to an output of the scale-up gated clock driver. In an aspect, the scale-up gated clock driver may be configured to receive a scale-up enabling signal and, in response, to drive the clock from the transceiver clock line onto the scale-up clock line. In an aspect, disclosed scalable bandwidth data interfaces may include scale-up clocked transceiver, which may be configured to transmit data to and receive data from a scale-up data lane in response to the clock on the scale-up clock line.

Other apparatuses for scalable bandwidth data interface are disclosed, and according to various aspects, example features can include a processor-side clocked transceiver and a memory-side clocked transceiver, each having a clock input; a data lane, extending from the processor-side clocked transceiver to the memory-side clocked transceiver; a processor-side scale-up clocked transceiver and a memory-side scale-up clocked transceiver, each having a clock input. Features may also include, for example, a scale-up data lane, which may extend from the processor-side scale-up clocked transceiver to the memory-side scale-up clocked transceiver. Other features can include a processor-side dynamically extendible clock line, which may include a processor-side base mode clock line, configured to carry a clock to the clock input of the processor-side clocked transceiver, a processor-side scale-up mode clock line, coupled to the clock input of the processor-side scale-up clocked transceiver. The processor-side scale-up gated clock driver may be configured to receive a scale-up enabling signal and, in response, to drive the clock from the processor-side base mode clock line onto the processor-side scale-up clock line. Example features can also include a memory-side dynamically extendible clock line, which may include a memory-side base mode clock line, configured to carry the clock to the clock input of the memory-side clocked transceiver. Further example features can include a memory-side scale-up clock line, coupled to the clock input of the memory-side scale-up clocked transceiver, and a memory-side scale-up gated clock driver configured to receive the scale-up enabling signal and, in response, to drive the clock from the memory-side base mode clock line onto the memory-side scale-up clock line.

Additional apparatus for scalable bandwidth data interface are disclosed, and according to various aspects, example features may include a processor-side clocked transceiver and a memory-side clocked transceiver that can couple, respectively, to a processor side and a memory side of a data lane that can extend from a processor to a memory, in addition to a processor-side scale-up clocked transceiver and a memory-side scale-up clocked transceiver that can couple, respectively, to a processor side and a memory side of a scale-up data lane that can extend from the processor to the memory. According to various aspects, example features may include means for switching from a base mode clocking to a scale-up mode clocking, wherein the means for switching from a base mode clocking to a scale-up mode clocking can be configured to include in the base mode clocking a concurrent clocking of the processor-side clocked transceiver and the memory-side clocked transceiver, with disabled clocking of the processor-side clocked transceiver or the memory-side clocked transceiver, and to include in the scale-up mode clocking a concurrent clocking of the processor-side scale-up clocked transceiver, the memory-side scale-up transceiver, the processor-side scale-up clocked transceiver and the memory-side scale-up clocked transceiver.

### BRIEF DESCRIPTION OF THE DRAWINGS

The accompanying drawings are presented to aid in the description of aspects and are provided solely for illustration not limitation thereof.

FIG. 1 shows a functional block schematic of one example dynamically scalable bandwidth memory access system.

FIG. 2 shows a superposition of a bandwidth mode map onto the FIG. 1 functional block schematic.

FIGS. 3A-3C show, respectively, three different mode states of one example dynamically scalable bandwidth memory access system.

FIGS. 4A-4C show, respectively, different lane utilizations and transfer durations for one example data transfer using the three different mode states shown in FIGS. 3A-3C.

FIG. 5 shows an illustrative set of different orderings provided by example selective prioritization aspects.

FIG. 6 shows one example memory access system incorporating dynamically scalable bandwidth memory access according to various aspects.

### DETAILED DESCRIPTION

Aspects are disclosed in the following description and related drawings. Various alterations that do not depart from the scope of the disclosed aspects may become apparent upon reading this disclosure. Additionally, in description of certain example applications, implementations and operations related to same, instances are identified, explicitly or implicitly from the described context, where known conventional techniques may be employed for certain components and acts. In such instances, detailed description of the employed conventional techniques may be omitted so as not to obscure relevant details of the disclosed aspects and concepts.

The word “exemplary” is used herein to mean “serving as an example, instance, or illustration.” Any aspect or example configuration of same that described herein as “exemplary” is not necessarily to be construed as preferred or advantageous over other aspects or configurations. Likewise, discussion of a feature, advantage or mode of operation in relation to the term “aspects” does not imply that all aspects include the discussed feature, advantage or mode of operation.

The terminology used herein is for the purpose of describing particular aspects only and is not intended to be limiting of the scope of practices. As used herein, the singular forms “a,” “an,” and “the” are intended to include the plural forms as well, unless the context clearly indicates otherwise. In addition, the terms “comprises,” “comprising,” “includes” and/or “including,” as used herein, specify the presence of stated features, integers, steps, operations, elements, and/or components, but do not preclude the presence or addition of one or more other features, integers, steps, operations, elements, components, and/or groups thereof.

Further, certain aspects are described in terms of example operations. It will be understood that except where otherwise described such operations can be performed by specific circuits (e.g., application specific integrated circuits (ASICs)), by program instructions being executed by one or more processors, or by a combination of both. In addition, specific circuits (e.g., ASICs), processors and program instructions executed by one or more of the same may be described as “logic configured to” perform described operations and action(s). Additionally, sequences of actions described herein can be considered to be embodied entirely within any form of computer readable storage medium having stored therein a corresponding set of computer instructions that upon execution would cause an associated processor to perform the functionality described herein. Thus, various aspects may be embodied in a number of different forms, all of which are contemplated to be within the scope of the claimed subject matter.

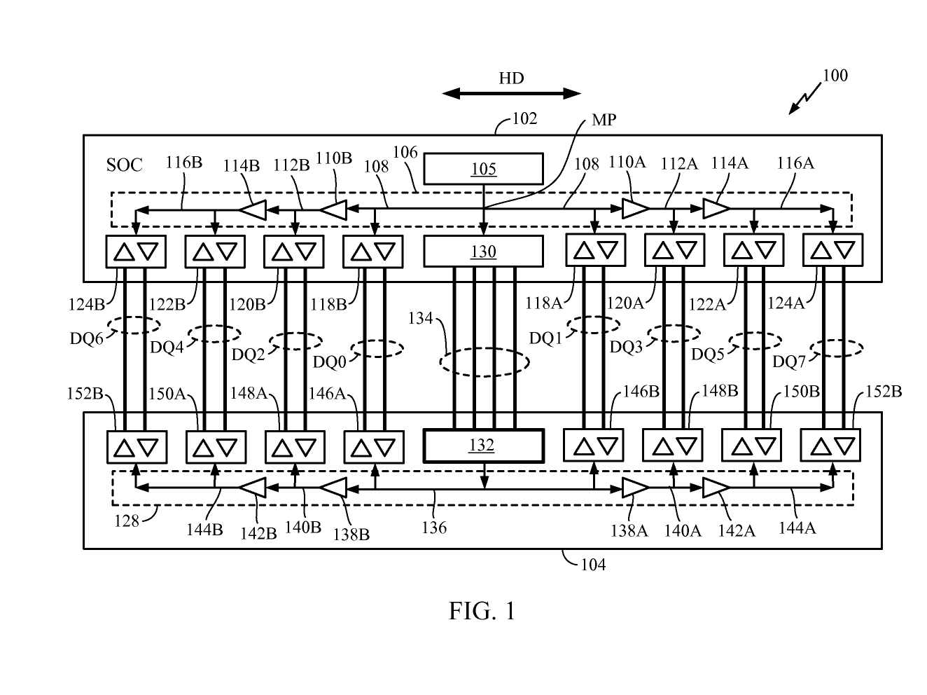

FIG. 1 shows a functional block schematic of example features of one dynamically scalable bandwidth memory access system 100 according to various aspects. For brevity, the expression “dynamically scalable bandwidth” will be abbreviated as “DSB.” It will be understood that “DSB,” as used in this description, is no more than an abbreviation of “dynamically scalable bandwidth” and is not intended to add additional meaning.

Referring to FIG. 1, in an aspect, the DSB memory access system 100 can include portions of a physical layer (PHY) of a system-on-chip (SOC) (not visible in its entirety in FIG. 1), relevant portions of which are represented by the SOC PHY 102. Other features of the SOC PHY 102 and of the SOC are not necessarily particular to the concepts and, therefore, further details are not explicitly visible in FIG.1. One example implementation that includes a more detailed example SOC, incorporating DSB memory interface according to various aspects, is described in further detail in reference to FIG. 7. The external memory device 104 can be an adaptation of features disclosed herein to conventional memory techniques. For example, the external memory device 104 can be an adaptation, with features shown in FIG. 1, of an otherwise conventional dynamic random access memory (DRAM).

In an aspect, the SOC PHY 102 can receive a data interface clock signal, termed “a clock” and labeled “TCK” for purposes of description, from a data interface clock generator 105. The data interface clock generator 105, for example, may be a functionality of a larger SOC associated with the SOC PHY 102. The SOC PHY 102 may include an SOC-side dynamically extendable clock line 106. The SOC-side dynamically extendable clock line 106 may comprise a portion that can be continuously enabled, such as the SOC-side transceiver clock line 108, in combination with other portions that can be selectively enabled and disabled, as described in further detail later in this disclosure. The SOC-side transceiver clock line 108 may be configured to receive TCK, for example, through a clock feed line 109. The SOC-side transceiver clock line 108 may extend linearly, between two distal ends (visible in FIG. 1 but not separately labeled). The distal ends of the SOC-side transceiver clock line 108 may be spaced apart in a direction, for example, aligned with the FIG. 1 axis HD. For purposes of description, the distal end of the SOC-side transceiver clock line 108 that is the furthest to the right, when viewing the FIG. 1 image plane from a perspective facing the sheet, may be termed the “first distal end of the SOC-side transceiver clock line 108.” The opposite distal end of the SOC-side transceiver clock line 108 may be termed the “second distal end of the SOC-side transceiver clock line 108.” It will be understood that the labels of “first” and “second” are arbitrarily assigned, with no intended meaning as to orientation with any frame of reference external to FIG. 1. In an aspect, clock feed line 109 can couple, for example, at or near a mid-point, labeled “MP” of the SOC-side transceiver clock line 108.

In an aspect, the SOC-side dynamically extendable clock line 106 may include an SOC-side scale-up first gated clock driver 110A having an input coupled to the first distal end of the SOC-side transceiver clock line 108 and an SOC-side scale-up second gated clock driver 110B having an input coupled to the second distal end of the SOC-side transceiver clock line 108. In an aspect, the SOC-side scale-up first gated clock driver 110A and the SOC-side scale-up second gated clock driver 110B can be configured to be selectively enabled and disabled by receiving (or not receiving) a scale-up enabling signal (not visible in FIG. 1). The scale-up enabling signal may be derived, for example, from a lane width command received from a memory controller in, or associated with the SOC PHY 102, as described later in further detail.

Referring to FIG. 1, in an aspect, a SOC-side scale-up first clock line 112A may have a proximal end (visible in FIG. 1 but not separately labeled) coupled to an output (visible in FIG. 1 but not separately labeled) of the SOC-side scale-up first gated clock driver 110A. The SOC-side scale-up first clock line 112A may extend outward in the first direction to a distal end (visible in FIG. 1 but not separately labeled). Similarly, a SOC-side scale-up second clock line 112B can have a proximal end (visible in FIG. 1 but not separately labeled) coupled to an output (visible in FIG. 1 but not separately labeled) of the SOC-side scale-up second gated clock driver 110B, and may extend outward in the second direction to a distal end (visible in FIG. 1 but not separately labeled). It will be understood that, in this context, “outward” means away from given center reference, such as the mid-point MP of the SOC-side transceiver clock line 108.

In an aspect, the distal end of the SOC-side scale-up first clock line 112A may be spaced in the first direction by a length, which will be termed for purposes of description as a “scale-up clock line length” from its proximal end at the output of the SOC-side scale-up first gated clock driver 110A. In a similar aspect, the distal end of the SOC-side scale-up second clock line 112B can be spaced in the second direction, for example, by the same scale-up clock line length, from its proximal end at the output of the SOC-side scale-up second gated clock driver 110B.

In an aspect, the distal end of the SOC-side scale-up first clock line 112A may connect to an input (visible in FIG. 1 but not separately labeled) of a SOC-side next scale-up first gated clock driver 114A. Similarly, the distal end of the SOC-side scale-up second clock line 112B may connect to an input (visible in FIG. 1 but not separately labeled) of a SOC-side next scale-up second gated clock driver 114B. The SOC-side next scale-up first gated clock driver 114A and the SOC-side next scale-up second gated clock driver 114B can be configured to be selectively enabled and disabled by receiving (or not receiving) a next scale-up enabling signal (not visible in FIG. 1). The next scale-up enabling signal may be derived, for example, from a lane width command received from a memory controller in, or associated with the SOC PHY 102, as mentioned above and as described later in further detail.

Referring to FIG. 1, in an aspect, a SOC-side next scale-up first clock line 116A may have a proximal end (visible in FIG. 1 but not separately labeled) coupled to an output (visible in FIG. 1 but not separately labeled) of the SOC-side next scale-up first gated clock driver 114A. The SOC-side next scale-up first clock line 116A may extend outward in the first direction to a distal end (visible in FIG. 1 but not separately labeled). Similarly, a SOC-side next scale-up second clock line 116B can have a proximal end (visible in FIG. 1 but not separately labeled) coupled to an output (visible in FIG. 1 but not separately labeled) of the SOC-side next scale-up second gated clock driver 114B, and may extend outward in the second direction to a distal end (visible in FIG. 1 but not separately labeled).

Regarding technology for implementing the SOC-side transceiver clock line 108, the SOC-side scale-up first clock line 112A, the SOC-side next scale-up first clock line 116A, the SOC-side scale-up second clock line 112B, and the SOC-side next scale-up second clock line 116B, the choice is not necessarily specific to the disclosed concepts. For example, selection of technology can be a design choice, which may be performed without undue experimentation by a person of ordinary skill facing a given application, by applying conventional design methodologies that such persons know to the present disclosure. Illustrative technologies can include, but are not limited to, conventional techniques of metal traces formed on a substrate. Such technology and may be employed in implementing similar structures that may be included in, or with the external memory device 104, as described in further detail in later sections.

Regarding technology in which the SOC-side scale-up first gated clock driver 110A, SOC-side next scale-up first gated clock driver 114A, SOC-side scale-up second gated clock driver 110B, and SOC-side next scale-up second gated clock driver 114B may be implemented, the choice is not necessarily specific to the disclosed concepts. For example, the selection of technology can be a design choice that may be performed without undue experimentation by a person of ordinary skill facing a specific application, by applying conventional clock driver selection and design methodologies that such persons know to the present disclosure. Such technology and design methodology may be employed to implement all remaining gated clock drivers described herein.

SOC-side clocked transceivers in the FIG. 1 example that may be clocked by the SOC-side dynamically extendable clock line 106 will now be described. Referring to FIG. 1, in an aspect, the SOC-side clocked transceivers may include an SOC-side base mode clocked transceiver, or can include a set of SOC-side base mode clocked transceivers. The example SOC-side base mode clocked transceivers shown in FIG. 1 comprise an SOC-side base mode first clocked transceiver 118A and an SOC-side base mode second clocked transceiver 118B. In an aspect, the clock inputs (visible in FIG. 1 but not separately labeled) of the SOC-side base mode first clocked transceiver 118A and the SOC-side base mode second clocked transceiver 118B may be coupled, for example, by a stub line (visible in FIG. 1 but not separately labeled) to the SOC-side transceiver clock line 108.

In an aspect, each of the SCO-side base-mode clocked transceivers can couple to an SOC side of a corresponding base mode data lane. In the FIG. 1 example, the SOC-side base mode first clocked transceiver 118A can couple to a SOC side (visible in FIG. 1 but not separately labeled) of a first data lane, e.g., the first data lane DQ0, and the SOC-side base mode second clocked transceiver 118B can couple to a SOC side (visible in FIG. 1 but not separately labeled) of a second data lane, e.g., the second data lane DQ1. According to this aspect, the first data lane DQ0 is a base mode first data lane and the second data lane DQ1 is a base mode second data lane. The first data lane DQ0 and the second data lane DQ1 can each be implemented, for example, as a differential transmission line (visible in FIG. 1 but not separately numbered). For purposes of description, the first data lane DQ0 and the second data lane DQ1 can be collectively referenced as “base mode data lanes DQ0-DQ1.” Also, since the FIG. 1 base mode data lanes DQ0-DQ1 show an example base mode bandwidth of two data lanes, the base mode data lanes DQ0-DQ1 can also be referred to as “×2 scale data lanes DQ0-DQ1.”

In the FIG. 1 example, the SOC-side base mode first clocked transceiver 118A and the SOC-side base mode second clocked transceiver 118B may be positioned symmetrically about the midpoint P of the SOC-side transceiver clock line 108. The symmetrical positioning is not intended as a limitation. Persons of ordinary skill in the art, upon reading the present disclosure in its entirety will appreciate, for example, that power savings may be obtained by the symmetrical positioning.

Referring to FIG. 1, the SOC-side clocked transceivers may further include a set of SOC-side scale-up clocked transceivers, for example, a SOC-side scale-up first clocked transceiver 120A and a SOC-side scale-up second clocked transceiver 120B. In an aspect, a clock input (visible in FIG. 1 but not separately labeled) of the SOC-side scale-up first clocked transceiver 120A may be coupled to the SOC-side scale-up second clock line 112B. Similarly, a clock input (visible in FIG. 1 but not separately labeled) of the SOC-side scale-up second clocked transceiver 120B may be coupled to the SOC-side scale-up first clock line 112A. The respective couplings may be provided, for example, by stub lines (visible in FIG. 1 but not separately labeled). As can be understood FIG. 1 and elsewhere in this disclosure, the example SOC-side clocked transceivers can be clocked by enabling the SOC-side scale-up first gated clock driver 110A and the SOC-side scale-up second gated clock driver 110B, to respectively drive the clock from the SOC-side transceiver clock line 108 onto the SOC-side scale-up first clock line 112A and onto the SOC-side scale-up second clock line 112B.

In an aspect, the set of SOC-side scale-up transceivers can couple to an SOC-side of a respective set of scale-up data lanes. For example, the SOC-side scale-up first clocked transceiver 120A can couple to a SOC side (visible in FIG. 1 but not separately labeled) of a third data lane DQ2, and the SOC-side scale-up second clocked transceiver 120B can couple to a SOC side (visible in FIG. 1 but not separately labeled) of a fourth data lane DQ3. The third data lane DQ2 may be alternatively referred to as a “scale-up first data lane,” and the fourth data lane DQ3 may be alternatively referred to as a “scale-up second data lane.” For purposes of description, the third data lane DQ2 and the fourth data lane DQ3 can be collectively referenced as “scale-up data lanes DQ2-DQ3.” Also, since the FIG. 1 scale-up data lanes DQ2-DQ3 show an example scale-up that doubles bandwidth provided by the ×2 scale date lanes Q0-Q1 alone, the data lanes DQ2-DQ3 can also be referred to as “×4 scale data lanes DQ2-DQ3.”

In an aspect, the SOC-side clocked transceivers may also include a set of next scale-up clocked transceivers. In a related aspect, the set of SOC-side next scale-up transceivers may couple to a SOC side of a respective set of next scale-up data lanes. In the FIG. 1 example, four next scale-up clocked transceivers are shown, comprising a SOC-side next scale-up first clocked transceiver 122A, a SOC-side next scale-up second clocked transceiver 122B, a SOC-side next scale-up third clocked transceiver 124A, and a SOC-side next scale-up fourth clocked transceiver 124B. In an aspect, respective clock inputs (visible in FIG. 1 but not separately labeled) of the SOC-side next scale-up first clocked transceiver 122A and of the SOC-side next scale-up third clocked transceiver 124A be coupled to the SOC-side next scale-up second clock line 116B. The coupling may be provided, for example, by stub lines (visible in FIG. 1 but not separately labeled). Similarly, respective clock inputs (visible in FIG. 1 but not separately labeled) of the SOC-side next scale-up second clocked transceiver 122B and of the SOC-side next scale-up fourth clocked transceiver 124B be coupled to the SOC-side next scale-up first clock line 116A. The coupling may be provided, for example, by stub lines (visible in FIG. 1 but not separately labeled).

As can be understood FIG. 1 and elsewhere in this disclosure, the example SOC-side next scale-up clocked transceivers can be clocked by a concurrent enabling of the SOC-side scale-up first gated clock driver 110A, the SOC-side scale-up second gated clock driver 110B, the SOC-side next scale-up first gated clock driver 114A, and the SOC-side next scale-up second gated clock driver 114B. Enabled as such, the SOC-side next scale-up first gated clock driver 114A drives the clock from the SOC-side scale-up first clock line 112A onto the SOC-side next scale-up first clock line 116A, and the SOC-side next scale-up second gated clock driver 114B drives the clock from the SOC-side scale-up second clock line 112B onto the SOC-side next scale-up second clock line 116B.

Referring to FIG. 1, the SOC-side next scale-up first clocked transceiver 122A can couple to a SOC end (visible in FIG. 1 but not separately labeled) of a next scale-up first data lane, for example, a fifth data lane DQ4. The SOC-side next scale-up second clocked transceiver 122B can couple to a SOC end (visible in FIG. 1 but not separately labeled) of a next scale-up second data lane, for example a sixth data lane DQ5. In like manner, the SOC-side next scale-up third clocked transceiver 124A can couple to a SOC end (visible in FIG. 1 but not separately labeled) of a next scale-up third lane, for example, a seventh data lane DQ6, and the SOC-side next scale-up fourth clocked transceiver 124B can couple to a SOC end (visible in FIG. 1 but not separately labeled) of a next scale-up fourth data lane, for example, an eighth data lane DQ7. For purposes of description, the third data lane DQ2 and the fourth data lane DQ3 can be collectively referenced as “scale-up data lanes DQ2-DQ3.” Also, since the FIG. 1 scale-up data lanes DQ2-DQ3 show an example scale-up that doubles a bandwidth provided by the ×2 scale date lanes Q0-Q1 alone, the data lanes DQ2-DQ3 can also be referred to as “×4 scale data lanes DQ2-DQ3.” Also for purposes of description, the third data lane DQ2 and the fourth data lane DQ3 can be collectively referenced, interchangeably, as “first scale-up data lanes DQ2-DQ3” and “×4 scale data lanes DQ2-DQ3.” In addition, for purposes of description, the fifth data lane DQ4, sixth data lane DQ5, seventh data lane DQ6, and eighth data lane DQ7 can be collectively referenced, interchangeably, as “second scale-up data lanes” DQ4-DQ7″ and as “×8 scale data lanes DQ4-DQ7.”

Referring to FIG. 1, a memory-side dynamically extendable clock line 128 may be arranged in, or proximal to the external memory device 104. The memory-side dynamically extendable clock line 128 may comprise a memory-side transceiver clock line 136, which may be configured according to the SOC-side transceiver clock line 108 that is described above. In an aspect, the memory-side transceiver clock line 136 may be configured to receive TCK from the SOC PHY 102, for example, from the clock and command bus 134. In an aspect, one or more memory-side scale-up gated clock drivers may have respective inputs coupled to the memory-side transceiver clock line 136. For example, a memory-side scale-up first gated clock driver 138A may have an input coupled to a first distal end (visible in FIG. 1 but not separately labeled) of the memory-side transceiver clock line 136, and a memory-side scale-up second gated clock driver 138B may have an input coupled to a second distal end (visible in FIG. 1 but not separately labeled) of the memory-side transceiver clock line 136, opposite the first distal end.

In an aspect, the memory-side scale-up first gated clock driver 138A and the memory-side scale-up second gated clock driver 138B can be configured to be selectively enabled and disabled, in unison with the SOC-side scale-up first gated clock driver 110A and the SOC-side scale-up second gated clock driver 110B. The enabling can be example, in response to scale-up enable signals, or data lane width commands or equivalents from the memory controller, described above, that may be in or associated with the SOC PHY 102. For example, a data lane width command may be received via the clock and command bus 134 from the memory controller.

Referring to FIG. 1, the memory-side dynamically extendable clock line 128 may comprise a memory-side scale-up first clock line 140A and a memory-side scale-up second clock line 140B. The memory-side scale-up first clock line 140A may have a proximal end (visible in FIG. 1 but not separately labeled) coupled to an output (visible in FIG. 1 but not separately labeled) of the memory-side scale-up first gated clock driver 138A, and may extend to a distal end (visible in FIG. 1 but not separately labeled). In like manner, the memory-side scale-up second clock line 140B may have a proximal end (visible in FIG. 1 but not separately labeled) coupled to an output (visible in FIG. 1 but not separately labeled) of the memory-side scale-up second gated clock driver 138B, and may extend to a distal end (visible in FIG. 1 but not separately labeled).

In an aspect, the memory-side scale-up first clock line 140A and the memory-side scale-up second clock line 140B may be configured similarly to the SOC-side scale-up first clock line 112A and the SOC-side scale-up second clock line 112B as described above. Coupled, for example, to the distal end of the memory-side scale-up first clock line 140A may be an input of a memory-side next scale-up first gated clock driver 142A. Coupled, for example, to the distal end of the memory-side scale-up second clock line 140B may be an input of a memory-side next scale-up second gated clock driver 142B. The memory-side next scale-up first gated clock driver 142A and the memory-side second next scale-up second gated clock driver 142B can be configured to be selectively enabled and disabled, for example, in response to next scale-up enable signals, or data lane width commands or equivalents via the clock and command bus 134, from the memory controller described above,

The memory-side dynamically extendable clock line 128 may further comprise a memory-side clock next scale-up first clock line 144A, and a memory-side next scale-up second clock line 144B. The memory-side next scale-up first clock line 144A may extend outward from a proximal end (visible in FIG. 1 but not separately labeled) coupled to an output (visible in FIG. 1 but not separately labeled) of the memory-side next scale-up first gated clock driver 142A, to a distal end. The memory-side next scale-up first clock line 144A may be configured, for example, such as the SOC-side next scale-up first clock line 116A described above. In an aspect, the memory-side next scale-up second clock line 144B may extend outward from a proximal end (visible in FIG. 1 but not separately labeled) coupled to an output (visible in FIG. 1 but not separately labeled) of the memory-side next scale-up second gated clock driver 142B, to distal end.

Referring to FIG. 1, arranged in or proximal to the external memory device 104 can be memory-side clocked transceivers. In an aspect, the memory-side clocked transceivers may include memory-side base mode clocked transceivers, which can correspond to the SOC-side base mode clocked transceivers described above. The FIG. 1 example includes a memory-side base mode first clocked transceiver 146A, and a memory-side base mode second clocked transceiver 146B. The memory-side base mode first clocked transceiver 146A may couple to a memory side of the first data lane DQ0, i.e., in this example, a memory side of the base mode first data lane. The memory-side base mode second clocked transceiver 146B may couple to a memory side of the second data lane DQ1, i.e., in this example, a memory side of the base mode second data lane. The clock inputs (visible in FIG. 1 but not separately labeled) of the memory-side base mode first clocked transceiver 146A and the memory-side base mode second clocked transceiver 146B may be coupled, for example, by a stub line (visible in FIG. 1 but not separately labeled) to the memory-side transceiver clock line 136.

Referring to FIG. 1, the memory-side clocked transceivers may include a set of memory-side scale-up clocked transceivers. The memory-side scale-up clocked transceivers can correspond to the SOC-side scale-up clocked transceivers. Accordingly, in the FIG. 1 example, a memory-side scale-up first clocked transceiver 148A and a memory-side scale-up second clocked transceiver 148B can correspond, respectively, to the SOC-side scale-up first clocked transceiver 120A and the SOC-side scale-up second clocked transceiver 120B.

In an aspect, a clock input (visible in FIG. 1 but not separately labeled) of the memory-side scale-up first clocked transceiver 148A may couple to the memory-side scale-up second clock line 140B, for example, by a stub line (visible in FIG. 1 but not separately labeled). Similarly, a clock input (visible in FIG. 1 but not separately labeled) of the memory-side scale-up second clocked transceiver 148B may couple to the memory-side clock line scale-up first clock line 140A, for example, by a stub line (visible in FIG. 1 but not separately labeled).

In an aspect, the memory-side scale-up first clocked transceiver 148A can couple to a memory side (visible in FIG. 1 but not separately labeled) of the third data lane DQ2, and the memory-side scale-up second clocked transceiver 148B can couple to a memory side (visible in FIG. 1 but not separately labeled) of the fourth data lane DQ3. In other words, each memory-side scale clock transceiver can couple to a memory side of a corresponding one of the scale-up data lanes DQ2-DQ3.

The memory-side clocked transceivers may also include a set of memory-side next scale-up clocked transceivers. In the FIG. 1 example, there are four memory-side next scale-up clocked transceivers, comprising a memory-side next scale-up first clocked transceiver 150A, a memory-side next scale-up second clocked transceiver 150B, a memory-side next scale-up third clocked transceiver 152A, and a memory-side next scale-up fourth clocked transceiver 152B. In an aspect, a clock input (visible in FIG. 1 but not separately labeled) of the memory-side next scale-up first clocked transceiver 150A and a clock input (visible in FIG. 1 but not separately labeled) of the memory-side next scale-up third clocked transceiver 152A can each couple to the memory-side next scale-up second clock line 144B. The couplings may be provided, for example, by respective stub lines (visible in FIG. 1 but not separately labeled). Similarly, a clock input (visible in FIG. 1 but not separately labeled) of the memory-side next scale-up second clocked transceiver 150B and a clock input (visible in FIG. 1 but not separately labeled) of the memory-side next scale-up fourth clocked transceiver 152B may each be coupled to the memory-side clock line next scale-up first clock line 144A. These couplings may be provided, for example, by respective stub lines (visible in FIG. 1 but not separately labeled).

Referring to FIG. 1, the memory-side next scale-up first clocked transceiver 150A can couple to a memory side (visible in FIG. 1 but not separately labeled) of the fifth data lane DQ4, and the memory-side next scale-up second clocked transceiver 150B can couple to a memory side (visible in FIG. 1 but not separately labeled) of the sixth data lane DQ5. In like manner, the memory-side next scale-up third clocked transceiver 152A can couple to a memory side (visible in FIG. 1 but not separately labeled) of the seventh data lane DQ6, and the memory-side next scale-up fourth clocked transceiver 152B can couple to a SOC side (visible in FIG. 1 but not separately labeled) of the eighth data lane DQ7.

It can be understood that the DSB memory access system 100 shows one example system capable of switching interface bandwidth, according to various aspects, between a base mode and one or more scale-up modes. In an aspect, one base mode operation can include clocking a processor-side base mode clocked transceiver that interfaces a base mode data lane between a processor and a memory, concurrent with not clocking a processor-side scale-up transceiver that interfaces a scale-up mode data lane between the processor and the memory. Referring to FIG. 1, examples of base mode operation include clocking the SOC-side base mode first clocked transceiver 118A and the base mode second clocked transceiver 118B concurrent with not clocking the SOC-side scale-up first clocked transceiver 120A and not clocking the SOC-side scale-up second clocked transceiver 120B. In a further aspect, switching to a scale-up mode can comprise a concurrent clocking of the processor-side base mode transceiver(s) and the processor-side scale-up clocked transceiver(s), while supplying a clock to a memory-side scale-up clocked transceiver(s) coupled to a memory side of a scale-up mode data lane. The concurrent clocking can comprise a concurrent enabling of the SOC-side scale-up first gated clock driver 110A, the SOC-side scale-up second gated clock driver 110B, the memory-side scale-up first gated clock driver 138A and the memory-side scale-up second gated clock driver 138B. Scaling the data interface bandwidth down at the processor can include disabling or ceasing the supplying the clock to the memory-side clocked transceivers coupled to the memory side of the scale-up mode data lanes, e.g., to the memory-side scale-up first clocked transceiver 148A and memory-side scale-up second clocked transceiver 148B.

Referring to FIG. 1, it can be understood that the DSB memory access system 100 can provide for scalable data bandwidth interfacing, and operations according to various aspects can include a concurrent clocking of a processor-side clocked transceiver and a memory-side clocked transceiver, such as the SOC-side base mode first clocked transceiver 118A and the memory-wide base mode first clocked transceiver 146A interfacing a processor side and a memory side of a base mode data lane, respectively, which extends from a processor to a memory. Example operations can further include, while clocking the processor-side clocked transceiver and the memory-side clocked transceiver, switching from a base bandwidth mode to a scale-up mode. In an aspect, the scale-up mode can include a concurrent clocking of a processor-side scale-up clocked transceiver, such as the SOC-side scale-up first clocked transceiver 120A, and a memory-side scale-up clocked transceiver, such as the memory-side scale-up first clocked transceiver 148A, interfacing a processor side and a memory side of a scale-up data lane, respectively, extending from the processor to the memory. In an aspect, the base bandwidth mode can include not clocking the processor-side scale-up transceiver, or not clocking the memory-side scale-up clocked transceiver, or both.

In an aspect, operations of a concurrent clocking the processor-side clocked transceiver and the memory-side clocked transceiver can include feeding a clock, through a processor-side clock line, for example, the SOC-side transceiver clock line 108, to a clock input of the processor-side clocked transceiver, concurrent with feeding the clock, through a memory-side base mode clock line, for example, the memory-side transceiver clock line 136, to a clock input of the memory-side clocked transceiver.

In an aspect, operations in processes of switching from the base bandwidth mode to the scale-up mode can include a concurrent enabling of a processor-side scale-up gated clock driver, such as the SOC-side scale-up first gated clock driver 110A or the SOC-side scale-up second gated clock driver 110B, and a memory-side scale-up gated clock driver, such as the memory-side scale-up first gated clock driver 138A, or the memory-side scale-up second gated clock driver 138B. In a related aspect, as described above, the processor-side scale-up gated clock driver, when enabled, can drive the clock from the processor-side transceiver clock line, e.g., the SOC-side transceiver clock line 108, through a processor-side scale-up clock line to a clock input of the processor-side scale-up clocked transceiver. As one non-limiting illustration, in FIG. 1, the SOC-side scale-up first gated clock driver 110A, when enabled, can drive the clock from the SOC-side transceiver clock line 108, through the SOC-side scale-up first clock line 112A, to a clock input of the processor-side scale-up clocked transceiver. In a like aspect, the memory-side scale-up gated clock driver, when enabled, can drive the clock from the memory-side clock line, through a memory-side scale-up clock line, to a clock input of the memory-side scale-up clocked transceiver.

In other aspects, example operations may include, concurrent with clocking the processor-side clocked transceiver and the memory-side clocked transceiver, switching from the scale-up mode to the base bandwidth mode. Operations related to switching from the scale-up mode to the base bandwidth mode can include, for example, disabling the processor-side scale-up gated clock driver, e.g., disabling the SOC-side scale-up first gated clock driver 110A, or disabling the memory-side scale-up gated clock driver, e.g., disabling the memory-side scale-up first gated clock driver 138A, or both. Examples of disabling the processor-side scale-up gated clock driver can also include, without limitation, disabling the SOC-side scale-up second gated clock driver 110B, or disabling the memory-side scale-up second gated clock driver 138B, or both.

In others aspects, example operations can include, concurrent with the clocking the processor-side clocked transceiver and the memory-side clocked transceiver, switching from the scale-up mode to a next scale-up mode. Operations in switching from the scale-up mode to the next scale-up mode may include, in relation to the next scale-up mode, a concurrent clocking of a processor-side next scale-up clocked transceiver, such as the SOC-side next scale-up first clocked transceiver 122A and a memory-side next scale-up clocked transceiver, such as the SOC-side next scale-up first clocked transceiver 150A respectively interfacing a processor side and a memory side of a next scale-up data lane, extending from the processor to the memory.

In another aspect, example operations in switching from the scale-up mode to the next scale-up mode can include a concurrent enabling of a processor-side next scale-up gated clock driver and a memory-side next scale-up gated clock driver, while the processor-side scale-up gated clock driver is enabled and the memory-side scale-up gated clock driver is enabled. Referring to FIG. 1, illustrative of such operations can be a concurrent enabling of the processor-side next scale-up first gated clock driver 114A and the memory-side next scale-up first gated clock driver 142A. That concurrent enabling can be performed while the processor-side scale-up first gated clock driver 110A is enabled and the memory-side scale-up first gated clock driver 138A is enabled. Such operations can provide a driving of the clock from the processor-side scale-up clock line, though a processor-side next scale-up clock line, to a clock input of the processor-side next scale-up clocked transceiver, and a driving of the clock from the memory-side scale-up clock line, through a memory-side next scale-up clock line, to a clock input of the memory-side next scale-up clocked transceiver.

Referring to FIG. 1, it will be understood that the SOC-side dynamically extendable clock line 106, and the memory-side dynamically extendable clock line 128 can provide means for switching from a base mode clocking to a scale-up mode clocking, wherein the means for switching from a base mode clocking to a scale-up mode clocking may be configured to include in the base mode clocking a concurrent clocking of the processor-side clocked transceiver and the memory-side clocked transceiver, with disabled clocking of the processor-side clocked transceiver or the memory-side clocked transceiver, and may be configured to include, in the scale-up mode clocking, a concurrent clocking of the processor-side scale-up clocked transceiver, the memory-side scale-up transceiver, the processor-side scale-up clocked transceiver and the memory-side scale-up clocked transceiver.

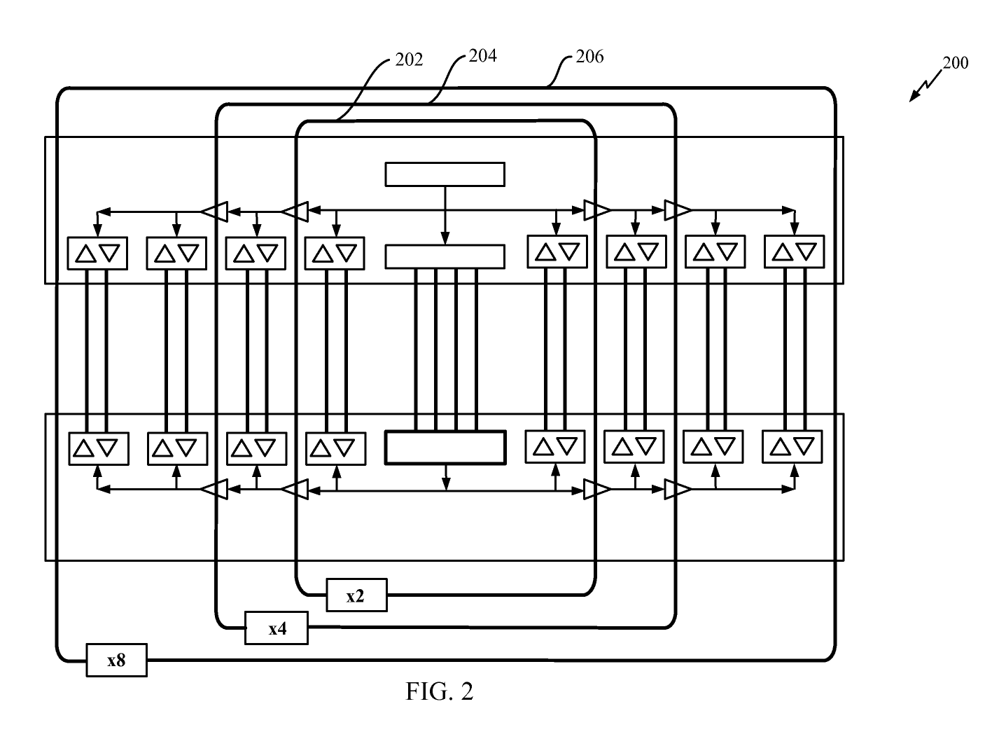

FIG. 2 shows a superposition 200 of one example data bandwidth mode map onto the FIG. 1 functional block schematic.

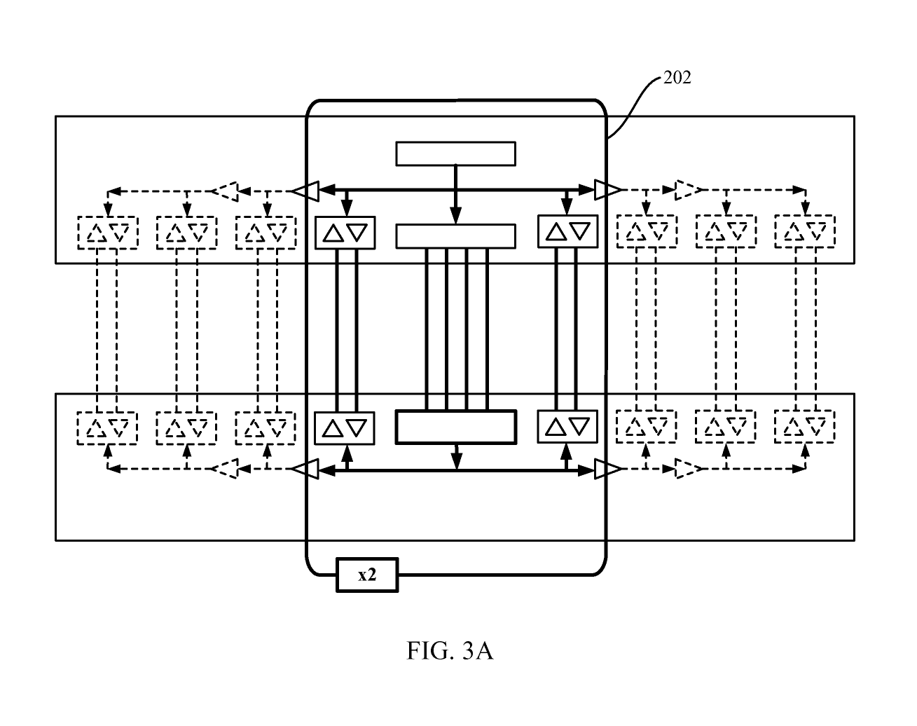

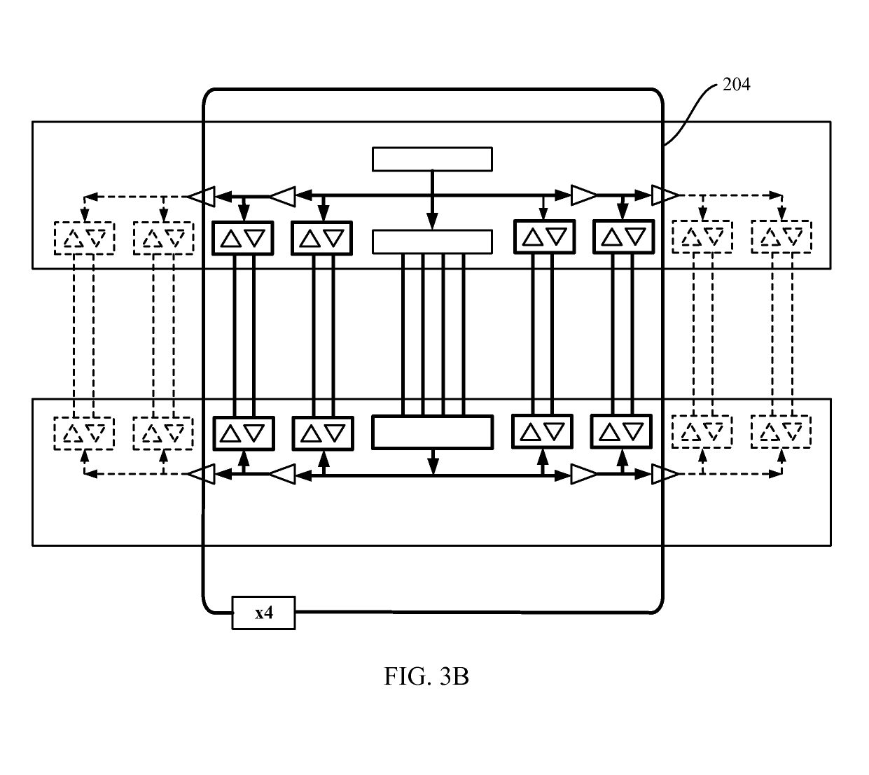

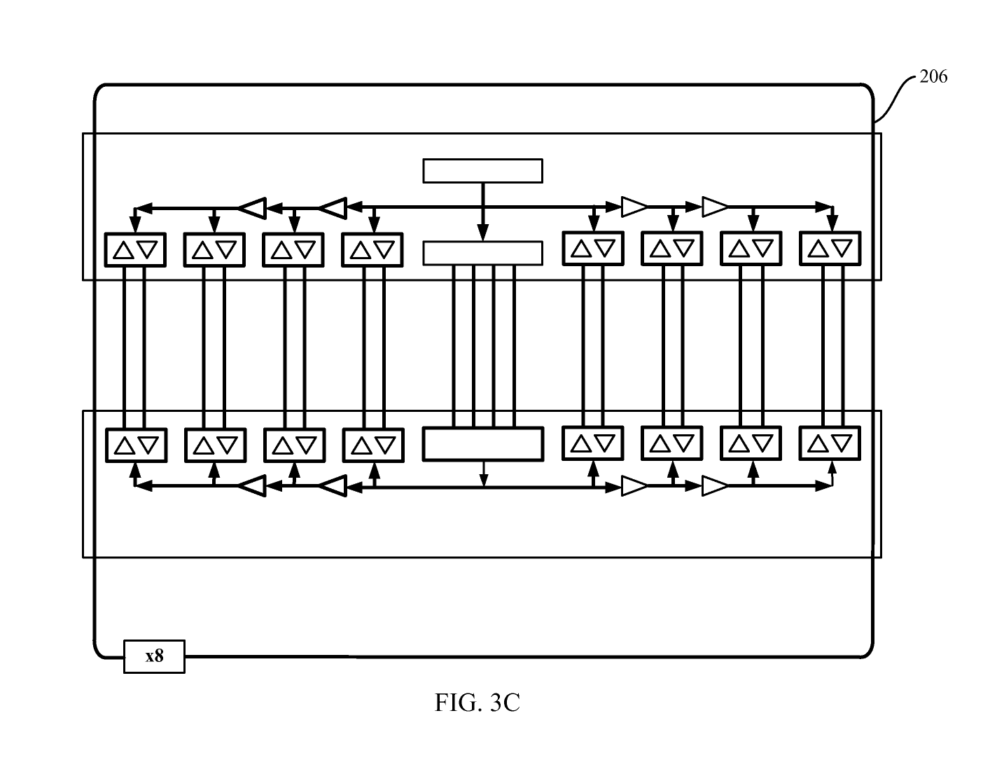

FIGS. 3A-3C show, respectively, the different data bandwidth mode states of the FIG. 1 example dynamically scalable bandwidth memory access system, corresponding to the mode boundaries shown by the FIG. 2 data bandwidth mode map.

Referring to FIG. 2, the DSB memory access system 100 visible in FIG. 1 is capable of being dynamically switched into three data bandwidth modes, indicated by TCK boundary 202, TCK boundary 204 and TCK boundary 206. The TCK boundary 202, TCK boundary 204 and TCK boundary 206 represent, respectively, the narrower and wider TCK distribution provided by each of the three active lengths to which the SOC-side dynamically extendible clock line 106 and the memory-side dynamically extendible clock line 128 can be scaled. The scaling can be performed, for example, by commands received from a memory controller in or associated with SOC PHY 102 that can cause enabling and disabling the SOC-side gated clock drivers and the memory-side gated clock drivers, as described above.

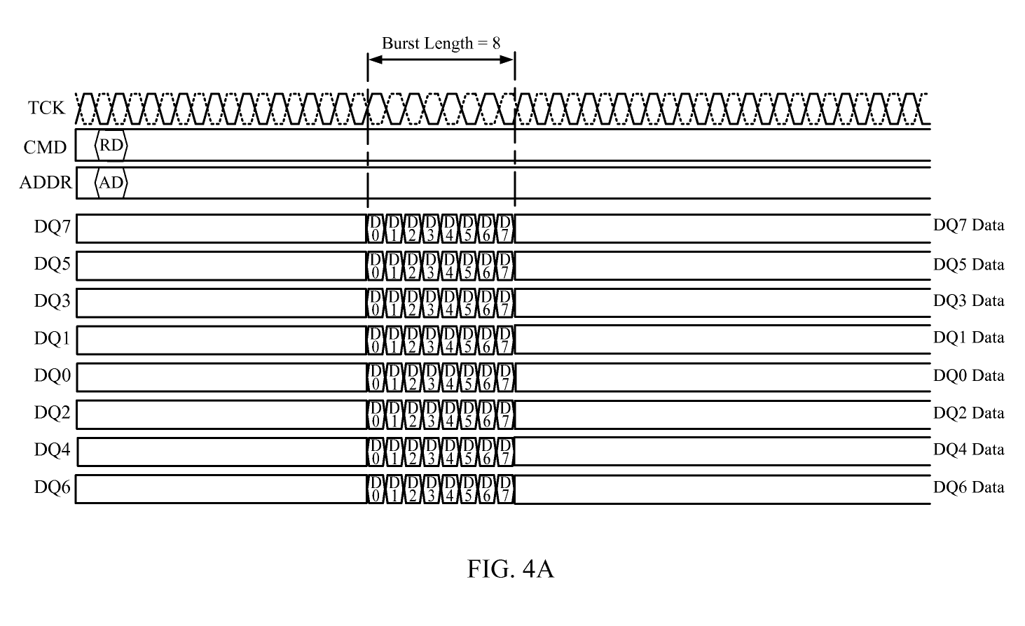

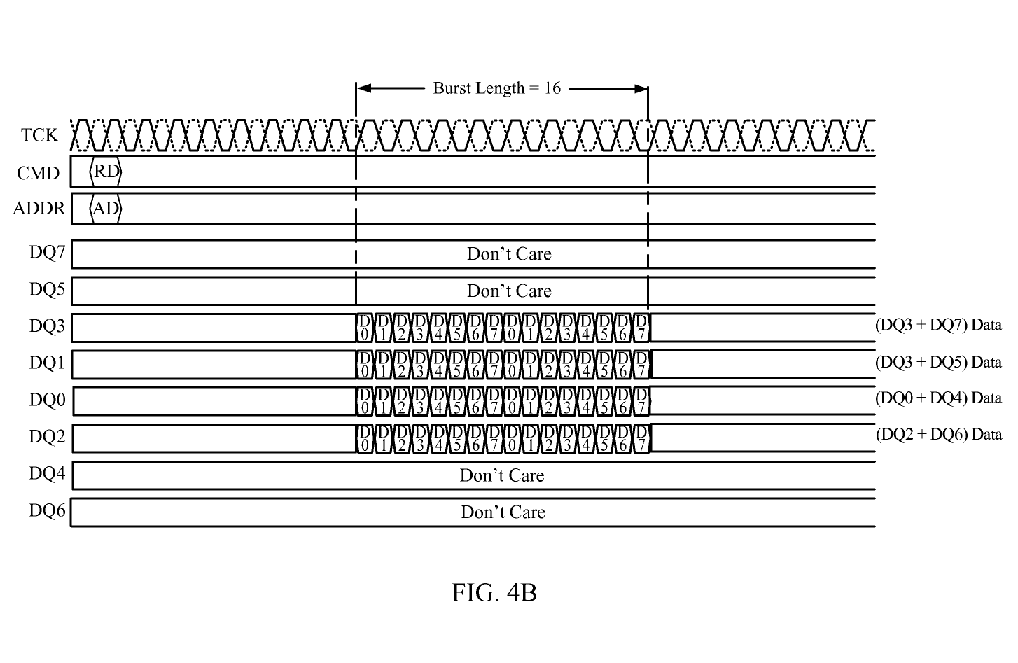

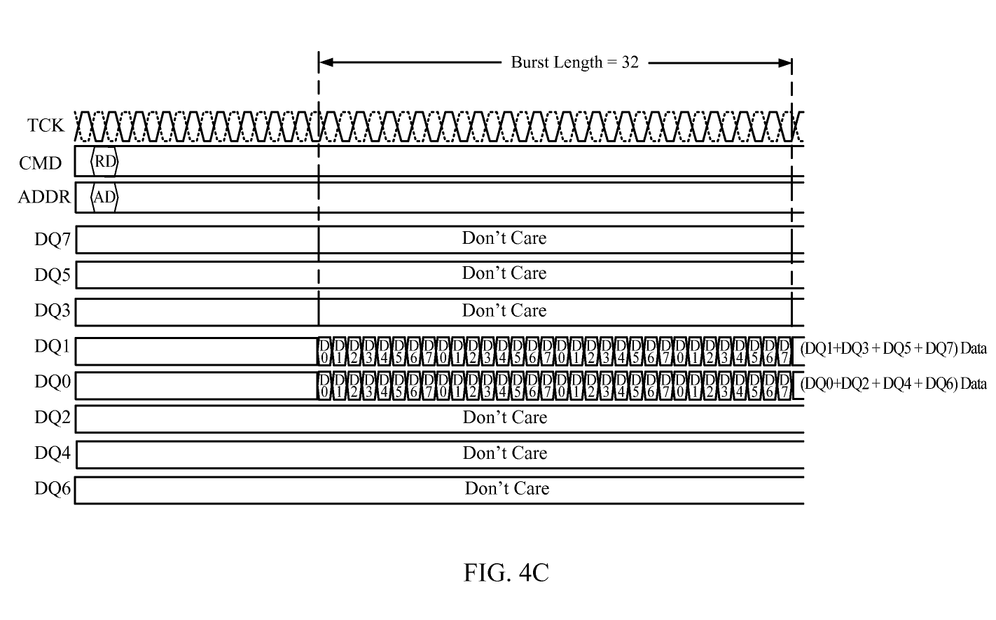

Referring to FIGS. 2 and 3A together, the lowest or base data bandwidth mode corresponds to the clock boundary 202. For the FIG. 1 example DSB memory access system 100, this is named in this description as the “×2” mode, as labeled on the FIG. 2 clock boundary 202 and on FIG. 3A. The name “×2” reflects that only two, DQ0 and DQ1 of the example data lanes DQ0-DQ7 are active. Referring to FIG. 4A, portions of the SOC-side dynamically extendible clock line 106 and of the memory-side dynamically extendible clock line 128 carrying TCK are shown in solid lines, and portions disabled, and therefore prevented from carrying TCK are in dotted lines. Similar, active data lanes (DQ0-DQ1) are in solid lines and inactive data lanes (DQ2-DQ7) are in dotted lines.

Referring to FIGS. 2 and 3B together, the middle or first scale-up data bandwidth mode corresponds to the clock boundary 304. For the FIG. 1 DSB memory access system 100, the middle or first scale-up mode can be termed the “×4” mode, as labeled on the FIG. 2 clock boundary 304 and on FIG. 4B. The name “×4” reflects four data lanes, DQ0-DQ3 of the example data lanes DQ0-DQ7 are active, which is twice the number active in the ×2 mode. Referring to FIG. 3B, portions of the SOC-side dynamically extendible clock line 106 and of the memory-side dynamically extendible clock line 128 carrying TCK are shown in solid lines, and portions disabled, and therefore prevented from carrying TCK are in dotted lines. As can be seen, the effective length of the SOC-side dynamically extendible clock line 106 and of the memory-side dynamically extendible clock line 128 is longer in the ×4 mode.

Referring to FIGS. 2 and 3C together, the maximum or second scale-up data bandwidth mode corresponds to the clock boundary 206. For the FIG. 1 DSB memory access system 100, this can be termed the “×8” mode, as labeled on the FIG. 2 clock boundary 206 and on FIG. 3C. The name “×8” reflects that all eight of the data lanes DQ0-DQ7 are active.

FIGS. 4A-4C show, respectively, different lane utilizations and burst durations for one example data transfer of 64 bits using the three different mode states shown in FIGS. 4A-4C. FIG. 4A shows the 64-bit transfer while the FIG. 1 DSB memory access system 100 is in the ×8, or full bandwidth or second scale-up mode shown in FIG. 3C. As visible on FIG. 4A, with the 8 data lanes DQ0-DQ7 active, the 64 bit transfer requires a burst of eight TCK clock cycles.

FIG. 4B shows the 64 bit transfer while the FIG. 1 DSB memory access system 100 in the ×4 mode or first scale-up mode shown in FIG. 3B, i.e., with the 4 data lanes DQ0-DQ3 active and DQ4-DQ7 being not clocked and therefore inactive. As seen on FIG. 4B, the 64-bit transfer, with DQ5-DQ7 inactive and therefore “don't care” with 64 bit transfer requires a burst of 16 TCK clock cycles. In other words, the same amount of data as transferred in the ×8 mode, but at one-half the rate. Power can be reduced, though, because the switching operations of clocking and moving data through the DQ5-DQ7 data lanes are shut down. It can be understood, therefore, that the communication device or other apparatus can dynamically adapt to lower bandwidth applications, without changing the TRK or system clock speed.

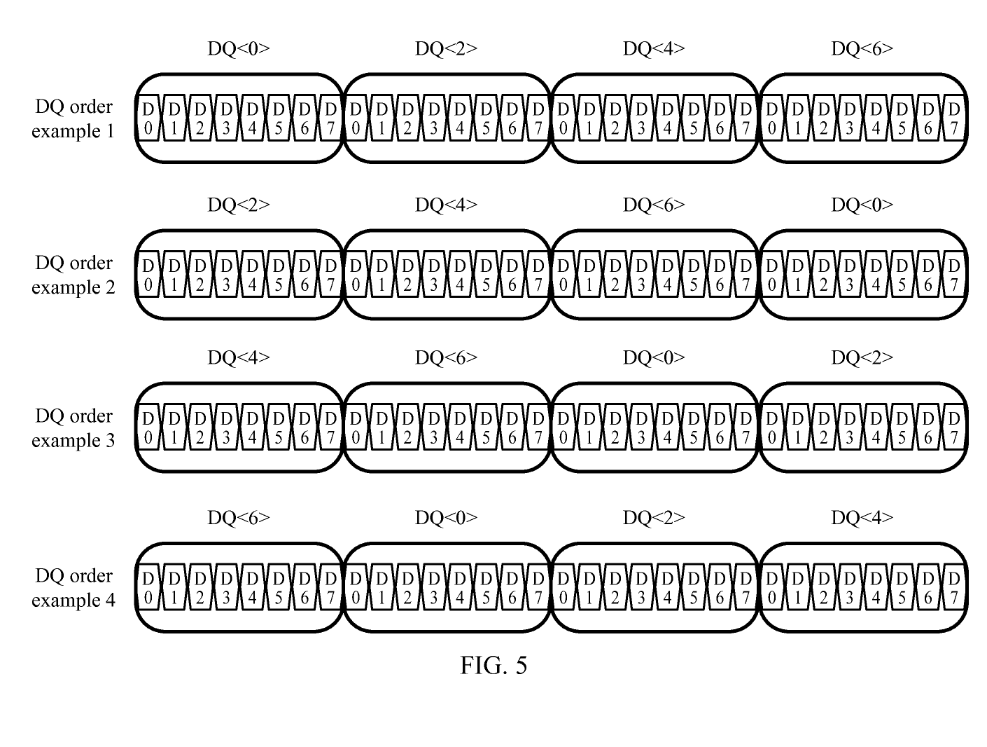

Referring again to FIG. 4B, the rightmost legend for the timing chart shows which inactive data lane data was carried by the active data lanes during the ×4 burst, As shown, the DQ3 data lane carried DQ3 data, as well as DQ7 data, and the DQ1 data lane carried DQ1 as well as DQ5 data. Similarly, the DQ0 data lane carried DQ0 and DQ4 data, and the DQ2 data lane carried DQ2 and DQ6 data. An effect of the data sharing can be delay. In an aspect, the ordering of shared data, basically “who gets to go first” can be set. In many applications, the delay incurred during lane shutdown can be acceptable. However, there are applications that require, or that can function better if memory access delays are better maintained under certain critical timing limits. In an aspect, dynamically scaling bandwidth with selective re-ordering may accommodate such applications, and can therefore save having to switch back to the maximum throughput mode shown in FIG. 4A. Example operations according to the re-ordering will be described in reference to FIG. 5.

FIG. 4C shows the 64 bit transfer while the FIG. 1 DSB memory access system 100 is in the ×2 mode or base mode. This corresponds to the state that is illustrated in FIG. 3A. As seen from FIGS. 3A and 4C, only two data lanes are open, namely DQ0 and DQ1. Six of the data lanes (DQ2-DQ7) are in a switched down, or “don't care” region. As seen on FIG. 4C, the 64-bit transfer, with DQ2-DQ7 inactive and therefore “don't care,” using the 64 bit transfer required a burst of 32 TCK clock cycles. In other words, the same amount of data as the transferred in the ×8 mode, at one-eighth the rate. Power may be conserved, of clocking and moving data through the DQ5-DQ7 data lanes are shut down.

Referring again to FIG. 4C, the rightmost legend for the timing chart shows which inactive data lane data was carried by the active data lanes during the burst, As shown, the DQ1 data lane carried DQ1 data, as well as DQ3, DQ5 and DQ7 data. The DQ0 data lane carried DQ0, in addition to carrying DQ2, DQ4, and DQ6. The above-described delay can therefore manifest more seriously and more frequently.

Accordingly, operations can include communicating data associated with each of a plurality of channels, for example a first data channel, a second data channel and a third data channel. It will be understood that there may be more than three data channels, and the first data channel, second data channel and third data channel are only an example.

In an aspect, when in the next scale-up mode, communicating data associated with the first data channel may comprise—using the present example of three data channels—communicating data over the base mode data lane, e.g., DQ0, and communicating data associated with the second data channel may comprise communicating data over a second data lane, e.g., DQ2, and communicating data associated with the third data channel may comprise communicating data over a third data lane, for example DQ4. It will be understood that the first data lane can be a base mode data lane, the second data lane a scale-up mode data lane, and the third data lane a next scale-up data lane. In another aspect, when in the base bandwidth mode, communicating data associated with the first data channel, the second data channel and the third data channel can be performed over the base mode data lane.

In an aspect, operations may include switching to the base bandwidth mode, and generating a read command, by a memory controller, in which the read command may include a priority code, and communicating the read command to the memory. In a further aspect, example operations may include communication a response to the read command, over a given data channel among the first data channel, the second data channel and the third data. In an aspect, the given data channel may be assigned an ordering, based on the priority code, relative to the other data channels among the first data channel, the second data channels, and the third data channel. In an aspect, the ordering may be configured to provide, in accordance with the priority code, a critical word first to the processor.

FIG. 5 shows an illustrative set 500 of different selective orderings provided by example operations of a selective prioritization aspect, and that can be included in dynamically scalable bandwidth memory access system.

Referring to FIG. 5, each of the data sequences represents a portion of a data burst exiting data channel DQ0 while in the ×2 mode. Referring to FIG. 4C it can be seen that during the ×2 mode, the DQ0 data lane carries DQ0, DQ2, DQ4 and DQ6, and the DQ1 data lane carries DQ1, DQ3, DQ5 and DQ7. Therefore unacceptable delays can occur more frequently.

For purposes of description, example operations are described in reference to the FIG. 1 DSB memory access system 100, when in the ×2 mode. Referring to FIG. 5, the four rows show four example prioritizations or orderings that may be applied. In an aspect, priority code may be included as a field in a read command (not explicitly visible,” and that priority code may be utilized to select, in the FIG. 5 example, which of the four possible re-orderings.

In an aspect, a memory controller, for example, in the SOC associated with the FIG. 1 SOC PHY 102, may generate a READ command that can specify the order among DQ0-DQ7 to apply during lane shutdown to a provide critical word first to SOC.

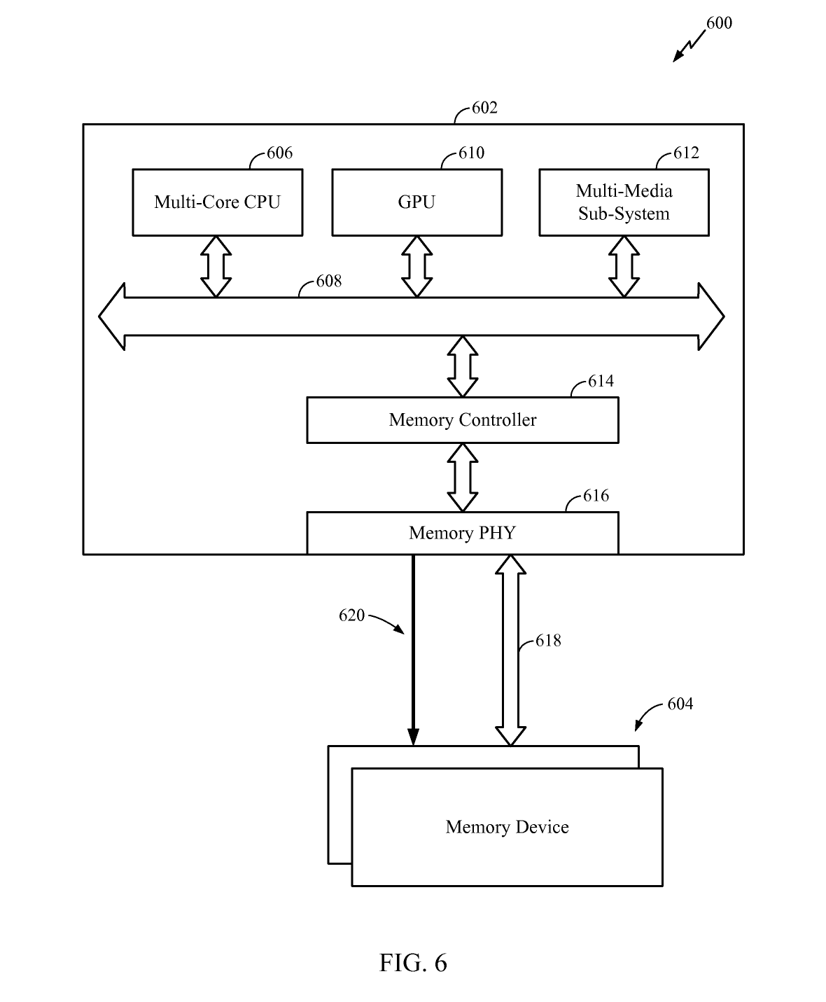

FIG. 6 shows one example memory access system incorporating a dynamically scalable bandwidth memory access system 600 according to various aspects. Referring to FIG. 6, the dynamically scalable bandwidth memory access system 600 can include an SOC 602 and a memory device 604 that is external to the SOC 602. The SOC 602 may comprise a multi-core central processing units (CPU) 606 that may be coupled to a fabric 608. A general programmable unit (GRU) 610 may also couple to the fabric 608. In an aspect, a multi-media sub-system 612 may coupled to the fabric 608 as well.

Access of the SOC 602 to the memory device 604 can be through a memory controller 614 that couples to a memory PHY 616. In an aspect memory, the memory PHY 616 may be configured according to the SOC PHY 102 of the FIG. 1 DSB memory access system 100. A data bus 618 couples the memory PHY 616 to the memory device 604. The data bus 618 may be configured as described for the data lanes DQ0-DQ7 described in reference to FIG. 1. In an aspect, the memory device 604 may be configured with interface circuitry such as described in reference to the FIG. 1 external memory device 104. In an aspect, the memory device 604 may be configured to interface the data bus 618 with selectively clocked transceivers (not visible in FIG. 1), and may include a switchable clock distribution network (not visible in FIG. 1) to perform the selective clocking. In an aspect, the memory device 604 may clock its clock transceivers through a dynamically extendable clock line, such as the FIG. 1 memory-side dynamically extendable clock line 128. In an aspect, the memory controller 614 may be configured to selectively enable and disable gated clock drivers arranged in (not visible in FIG. 6) the Memory PHY 616 and in the memory device 604.

In an aspect, the memory controller 614 may be configured to dynamically change a lane width (i.e., number of enabled data lanes) of the data bus, and therefore dynamically change memory data bandwidth. The memory controller 614 may, for example, change the memory data bandwidth in a manner dynamically responsive to memory work loads, for example, from a plurality of sub-systems which may be internal to the SOC 602. The memory controller 614 may be configured, for example, to monitor or detect memory workloads of the multi-core CPU 606, the GPU 610, and the multi-media sub-system 612. In an aspect, the memory controller 614 may be configured to change the lane width of the data bus 618 by setting land width values in DRAM mode registers (not explicitly visible in FIG. 1) in the memory device 604. In another aspect, the memory controller 614 may be configured to control the lane width of the data bus 618 by forwarding lane width information with a control and address information, over the CA/CLK bus 620, to the memory device 604.

It will be understood that implementations and practices are not limited to the example SOC-side and memory-side arrangements described above. For example, the SOC-side features may be formed or configured in a processor not configured as a SOC. As illustration, a processor-side scale-up first clocked transceiver and a processor-side scale-up second clocked transceiver may be arranged, for example in a processor, in a configuration such as the FIG. 1 SOC-side scale-up first clocked transceiver 120A and SOC-side scale-up second clocked transceiver 120B. Similarly, a processor-side next scale-up first clocked transceiver and a processor-side next scale-up second clocked transceiver may be arranged, for example in a processor, in a configuration such as the FIG. 1 SOC-side next scale-up first clocked transceiver 122A and SOC-side next scale-up second clocked transceiver 122B. A processor-side scale-up first clock line and processor-side scale-up second clock line may be arranged, for example in a processor, in a configuration such as the SOC-side scale-up first clock line 112A and SOC-side scale-up second clock line 112B. Further, a processor-side next scale-up first clock line and processor-side next scale-up second clock line may be arranged, for example in a processor, in a configuration such as the FIG. 1 SOC-side next scale-up first clock line 116A and SOC-side next scale-up second clock line 116B. Likewise a processor-side scale-up first gated clock driver and processor-side scale-up second gated clock driver may be arranged, for example in a processor, in a configuration such as the FIG. 1 SOC-side scale-up first gated clock driver 110A and SOC-side scale-up second gated clock driver 110B. In an aspect, a processor-side next scale-up first gated clock driver and a processor-side next scale-up second gated clock driver may be arranged, for example in a processor, in a configuration such as the FIG. 1 SOC-side next scale-up first gated clock driver 114A and SOC-side next scale-up second gated clock driver 114B.

In addition, an example dynamically scalable interface according to one or more aspects can include a transceiver clock line, in a device other than a processor or other SOC device, configured to carry a clock. Features may include, for example in the device, a clocked transceiver, which may be configured to transmit data to and receive data from a data lane, in response to the clock on the transceiver clock line. Such features may be implemented by structure, for example in the device, configured as the SOC-side transceiver clock line 108, and SOC-side base mode first clocked transceiver 118A. In an aspect, features can include, for example in the device, a scale-up gated clock driver, arranged such as the SOC-side first gated clock driver 110A, having an input coupled to the transceiver clock line, and may include a scale-up clock line, configured such as the SOC-side scale-up first clock line 112A, coupled to an output of the scale-up gated clock driver. In an aspect, the scale-up gated clock driver can be configured to receive a scale-up enabling signal and, in response, to drive the clock from the transceiver clock line onto the scale-up clock line. Also in the device may be a scale-up clocked transceiver, such as the SOC-side scale-up first clocked transceiver 120A, may configured to transmit data to and receive data from a scale-up data lane, such as the FIG. 1 scale-up first data lane, in response to the clock on the scale-up clock line.

A dynamically scalable interfaces according to various aspects can further include, for example in the device, a next scale-up first gated clock driver, having an input coupled to the scale-up first clock line, and a next scale-up second gated clock driver, having an input coupled to the scale-up clock line. Referring to FIG. 1, implementing structure can be, for example, arranged such as the next scale-up first gated clock driver 114A, having an input coupled to the scale-up first clock line 112A, and the next scale-up second gated clock driver 114B, having an input coupled to the scale-up second clock line 112B. Features can also include, for example in the device, a next scale-up first clock line, coupled to an output of the next scale-up first gated clock driver, wherein the next scale-up first gated clock driver can be configured to receive a next scale-up enabling signal and, in response, to drive the clock from the scale-up first clock line onto the next scale-up first clock line. Referring to FIG. 1, example implementations can be configured such as the next scale-up first clock line 116A, coupled to an output of the next scale-up first gated clock driver 114A.

In an aspect, features can also include a next scale-up second clock line, for example, in the device, coupled to an output of the next scale-up second gated clock driver, wherein the next scale-up second gated clock driver is configured to receive the next scale-up enabling signal and, in response, to drive the clock from the scale-up first clock line onto the next scale-up first clock line. Referring to FIG. 1, example implementations can include structure configured such as next scale-up second clock line 116B, coupled to an output of the next scale-up second gated clock driver 114A. As shown in FIG. 1, in an aspect, the next scale-up first clock line (e.g., the SOC-side next scale-up first clock line 116A) may configured to extend in the first direction from the output of the next scale-up first gated clock driver, and the next scale-up second clock line may be configured to extend in the second direction from the output of the next scale-up second gated clock driver.

In an aspect, features can include, for example in the device, a next scale-up first clocked transceiver, which may be configured to send data to, or receive data from a next scale-up first data lane, or both, in response to the clock on the next scale-up first clock line, and a next scale-up second clocked transceiver, configured to send data to, or receive data from a next scale-up second data lane, or both, in response to the clock on the next scale-up second clock line. Referring to FIG. 1, implementations of the next scale-up first clocked transceiver feature can include, for example, the SOC-side next scale-up first clocked transceiver 122A, or the SOC-side next scale-up third clocked transceiver 124. Example implementations of the next scale-up second clocked transceiver feature can include, for example, the SOC-side next scale-up second clocked transceiver 122B, or the SOC-side next scale-up fourth clocked transceiver 124B.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the aspects disclosed herein.

The methods, sequences and/or algorithms described in connection with the examples disclosed herein may be implemented directly in hardware, in a software module executed by a processor, or in a combination of the two. A software module may reside in a computer-readable storage medium such as, without limitation, a RAM memory, flash memory, ROM memory, EPROM memory, EEPROM memory, registers, hard disk, a removable disk, a CD-ROM, or any other form of storage medium known in the art. An exemplary storage medium can be coupled to the processor such that the processor can read information from, and write information to, the storage medium. In the alternative, the storage medium may be integral to the processor.

While the foregoing disclosure shows illustrative implementations, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for scalable data bandwidth interfacing, comprising:
a concurrent clocking of a processor-side clocked transceiver and a memory-side clocked transceiver, interfacing a processor side and a memory side of a base mode data lane, respectively, which extends from a processor to a memory; and
while clocking the processor-side clocked transceiver and the memory-side clocked transceiver, switching from a base bandwidth mode to a scale-up mode,
wherein the scale-up mode comprises a concurrent clocking of a processor-side scale-up clocked transceiver and a memory-side scale-up clocked transceiver, interfacing a processor side and a memory side of a scale-up data lane, respectively, which extends from the processor to the memory,
wherein the base bandwidth mode comprises disabling a clocking of the processor-side scale-up clocked transceiver, or disabling a clocking of the memory-side scale-up clocked transceiver, or both.

2. The method of claim 1, wherein the concurrent clocking of the processor-side clocked transceiver and the memory-side clocked transceiver comprises feeding a clock, through a processor-side clock line, to a clock input of the processor-side clocked transceiver, concurrent with feeding the clock, through a memory-side clock line, to a clock input of the memory-side clocked transceiver.

3. The method of claim 2, wherein switching from the base bandwidth mode to the scale-up mode comprises a concurrent enabling of a processor-side scale-up gated clock driver and a memory-side scale-up gated clock driver,
wherein the processor-side scale-up gated clock driver, when enabled, drives the clock from the processor-side clock line, though a processor-side scale-up clock line, to a clock input of the processor-side scale-up clocked transceiver, and
wherein the memory-side scale-up gated clock driver, when enabled, drives the clock from the memory-side clock line, through a memory-side scale-up clock line, to a clock input of the memory-side scale-up clocked transceiver.

4. The method of claim 3, further comprising: concurrent with the concurrent clocking of the processor-side clocked transceiver and the memory-side clocked transceiver, switching from the scale-up mode to the base bandwidth mode,
wherein switching from the scale-up mode to the base bandwidth mode comprises disabling the processor-side scale-up gated clock driver, or disabling the memory-side scale-up gated clock driver, or both.

5. The method of claim 3, further comprising: concurrent with the concurrent clocking of the processor-side clocked transceiver and the memory-side clocked transceiver, switching from the scale-up mode to a next scale-up mode,
wherein the next scale-up mode is configured to include a concurrent clocking of a processor-side next scale-up clocked transceiver and a memory-side next scale-up clocked transceiver, respectively interfacing a processor side and a memory side of a next scale-up data lane, extending from the processor to the memory.

6. The method of claim 5, wherein switching from the scale-up mode to the next scale-up mode comprises a concurrent enabling of a processor-side next scale-up gated clock driver and a memory-side next scale-up gated clock driver, while the processor-side scale-up gated clock driver is enabled and the memory-side scale-up gated clock driver is enabled,
wherein the processor-side next scale-up gated clock driver, when enabled while the processor-side scale-up gated clock driver is enabled, drives the clock from the processor-side scale-up clock line, though a processor-side next scale-up clock line, to a clock input of the processor-side next scale-up clocked transceiver, and
wherein the memory-side scale-up gated clock driver, when enabled while the memory-side scale-up gated clock driver is enabled, drives the clock from the memory-side scale-up clock line, through a memory-side next scale-up clock line, to a clock input of the memory-side next scale-up clocked transceiver.

7. The method of claim 6, further comprising communicating data associated with a first data channel, a second data channel and a third data channel,
wherein, in the next scale-up mode, the communicating data associated with the first data channel is performed over the base mode data lane, the communicating data associated with the second data channel is performed over a second data lane, and the communicating data associated with the third data channel is performed over a third data lane, and
wherein, in the base bandwidth mode, the communicating data associated with the first data channel is performed over the base mode data lane, the communicating data associated with the second data channel is performed over the base mode data lane, and the communicating data associated with the third data channel is performed over the base mode data lane.

8. The method of claim 7, further comprising:
switching to the base bandwidth mode;
generating a read command, by a memory controller, wherein the read command includes a priority code;
communicating the read command to the memory; and
communication a response to the read command, over a given data channel among the first data channel, the second data channel and the third data channel,
wherein the given data channel is assigned an ordering, based on the priority code, relative to the other data channels among the first data channel, the second data channel, and the third data channel.

9. The method according to claim 8, wherein the ordering is configured to provide, in accordance with the priority code, a critical word first to the processor.

10. A scalable bandwidth data interface, comprising;
a transceiver clock line, configured to carry a clock;
a clocked transceiver, configured to transmit data to and receive data from a data lane, in response to the clock on the transceiver clock line;
a scale-up gated clock driver, having an input coupled to the transceiver clock line;
a scale-up clock line, coupled to an output of the scale-up gated clock driver, and configured to receive a scale-up enabling signal and, in response, to drive the clock from the transceiver clock line onto the scale-up clock line; and
a scale-up clocked transceiver, configured to transmit data to and receive data from a scale-up data lane in response to the clock on the scale-up clock line.

11. The scalable bandwidth data interface of claim 10, wherein the scale-up gated clock driver is configured as a scale-up first gated clock driver, the scale-up clock line is configured as a scale-up first clock line, and the scale-up clocked transceiver is configured as a scale-up first clocked transceiver, and wherein the scalable bandwidth data interface further comprises:
a scale-up second gated clock driver, wherein the scale-up second gated clock driver includes an input coupled to the transceiver clock line;
a scale-up second clock line, coupled to an output of the scale-up second gated clock driver, and configured to receive the scale-up enabling signal and, in response, to drive the clock from the transceiver clock line onto the scale-up second clock line; and
a scale-up second clocked transceiver, configured to transmit and receive data over a scale-up second data lane, in response to the clock on the scale-up second clock line.

12. The scalable bandwidth data interface of claim 11, wherein the transceiver clock line includes a midpoint, wherein the scale-up first gated clock driver has an input spaced from the midpoint by a distance, in a first direction, wherein the scale-up first clock line extends, in the first direction, from an output of the scale-up first gated clock driver,
wherein the scale-up second gated clock driver has an input spaced from the midpoint, in a second direction, wherein the second direction is opposite the first direction, wherein the scale-up first clock line is configured to extend from an output of the scale-up second gated clock driver, in the second direction.

13. The scalable bandwidth data interface of claim 12, further comprising:
a next scale-up first gated clock driver, having an input coupled to the scale-up first clock line;
a next scale-up second gated clock driver, having an input coupled to the scale-up second clock line;
a next scale-up first clock line, coupled to an output of the next scale-up first gated clock driver, wherein the next scale-up first gated clock driver is configured to receive a next scale-up enabling signal and, in response, to drive the clock from the scale-up first clock line onto the next scale-up first clock line; and
a next scale-up second clock line, coupled to an output of the next scale-up second gated clock driver, wherein the next scale-up second gated clock driver is configured to receive the next scale-up enabling signal and, in response, to drive the clock from the scale-up first clock line onto the next scale-up first clock line.

14. The scalable bandwidth data interface of claim 13, further comprising:
a next scale-up first clocked transceiver, configured to send data to, or receive data from a next scale-up first data lane, or both, in response to the clock on the next scale-up first clock line; and
a next scale-up second clocked transceiver, configured to send data to, or receive data from a next scale-up second data lane, or both, in response to the clock on the next scale-up second clock line.

15. The scalable bandwidth data interface of claim 14, wherein the next scale-up first clock line is configured to extend in the first direction from the output of the next scale-up first gated clock driver, and wherein the next scale-up second clock line is configured to extend in the second direction from the output of the next scale-up second gated clock driver.

16. A scalable bandwidth data interface, comprising;
a processor-side clocked transceiver and a memory-side clocked transceiver, each having a clock input;
a data lane, extending from the processor-side clocked transceiver to the memory-side clocked transceiver;
a processor-side scale-up clocked transceiver and a memory-side scale-up clocked transceiver, each having a clock input;
a scale-up data lane, extending from the processor-side scale-up clocked transceiver to the memory-side scale-up clocked transceiver;
a processor-side dynamically extendible clock line, including a processor-side base mode clock line, configured to carry a clock to the clock input of the processor-side clocked transceiver, and a processor-side scale-up clock line, coupled to the clock input of the processor-side scale-up clocked transceiver, and a processor-side scale-up gated clock driver configured to receive a scale-up enabling signal and, in response, to drive the clock from the processor-side base mode clock line onto the processor-side scale-up clock line; and
a memory-side dynamically extendible clock line, including a memory-side clock line, configured to carry the clock to the clock input of the memory-side clocked transceiver, a memory-side scale-up clock line, coupled to the clock input of the memory-side scale-up clocked transceiver, and a memory-side scale-up gated clock driver configured to receive the scale-up enabling signal and, in response, to drive the clock from the memory-side clock line onto the memory-side scale-up clock line.

17. The scalable bandwidth data interface of claim 16, wherein the processor-side scale-up gated clock driver is a processor-side scale-up first gated clock driver, and the processor-side scale-up clock line is a processor-side scale-up first clock line, and the processor-side scale-up clocked transceiver is a processor-side scale-up first clocked transceiver, and wherein the scalable bandwidth data interface further comprises:
a processor-side scale-up second gated clock driver, having an input coupled to the processor-side clock line;
a processor-side scale-up second clock line, coupled to an output of the processor-side scale-up second gated clock driver, and configured to receive the scale-up enabling signal and, in response, to drive the clock from the processor-side clock line onto the processor-side scale-up second clock line; and
a processor-side scale-up second clocked transceiver, configured to transmit and receive data over a scale-up second data lane, in response to the clock on the processor-side scale-up second clock line.

18. The scalable bandwidth data interface of claim 17, wherein the memory-side scale-up gated clock driver is a memory-side scale-up first gated clock driver, the memory-side scale-up clock line is a memory-side scale-up first clock line, and the memory-side scale-up clocked transceiver is a memory -side scale-up first clocked transceiver, and wherein the scalable bandwidth data interface further comprises:
a memory-side scale-up second gated clock driver, having an input coupled to the memory-side clock line;
a memory-side scale-up second clock line, coupled to an output of the memory-side scale-up second gated clock driver, and configured to receive the scale-up enabling signal and, in response, to drive the clock from the memory -side clock line onto the memory-side scale-up second clock line; and
a memory-side scale-up second clocked transceiver, configured to transmit and receive data at a memory side of the scale-up second data lane, in response to the clock on the memory-side scale-up second clock line.

19. The scalable bandwidth data interface of claim 18, wherein the processor-side dynamically extendible clock line further comprises:
a processor-side next scale-up first gated clock driver, having an input coupled to the processor-side scale-up first clock line;
a processor-side next scale-up second gated clock driver, having an input coupled to the processor-side scale-up second clock line;
a processor-side next scale-up first clock line, coupled to an output of the processor-side next scale-up first gated clock driver, and configured to receive a next scale-up enabling signal and, in response, to drive the clock from the processor-side scale-up first clock line onto the processor-side next scale-up first clock line;
a processor-side next scale-up second clock line, coupled to an output of the processor-side next scale-up second gated clock driver, and configured to receive the next scale-up enabling signal and, in response, to drive the clock from the processor-side scale-up second clock line onto the processor-side next scale-up second clock line, and wherein the scalable bandwidth data interface further comprises:
a processor-side next scale-up first clocked transceiver, configured to transmit to and receive data from a next scale-up first data lane, in response to the clock on the processor-side next scale-up first clock line; and
a processor-side next scale-up second clocked transceiver, configured to transmit to and receive data from a next scale-up second data lane, in response to the clock on the processor-side next scale-up second clock line.

20. The scalable bandwidth data interface of claim 18, wherein the processor-side scale-up first clock line is configured to extend from an output of the processor-side scale-up first gated clock driver, in a first direction,
wherein the processor-side scale-up second clock line is configured to extend from an output of the processor-side scale-up second gated clock driver, in a second direction, wherein the second direction is opposite the first direction.

21. The scalable bandwidth data interface of claim 20, further comprising:
a processor-side next scale-up first gated clock driver, having an input coupled to the processor-side scale-up first clock line;
a processor-side next scale-up second gated clock driver, having an input coupled to the processor-side scale-up second clock line;
a processor-side next scale-up first clock line, coupled to an output of the processor-side next scale-up first gated clock driver and extending in the first direction; and
a processor-side next scale-up second clock line, coupled to an output of the processor-side next scale-up second gated clock driver and extending in the second direction.

22. The scalable bandwidth data interface of claim 21, wherein the processor-side next scale-up second gated clock driver is configured to receive a next scale-up enabling signal and, in response, to drive the clock from the processor-side scale-up first clock line onto the processor-side next scale-up first clock line, and
wherein the processor-side next scale-up second gated clock driver is configured to receive the next scale-up enabling signal and, in response, to drive the clock from the processor-side scale-up second clock line onto the processor-side next scale-up second clock line.

23. The scalable bandwidth data interface of claim 22, further comprising:
a processor-side next scale-up first clocked transceiver, configured to send data to, or receive data from a next scale-up mode first data lane, or both, in response to the clock on the processor-side next scale-up first clock line; and
a processor-side next scale-up second clocked transceiver, configured to send data to, or receive data from a next scale-up mode second data lane, or both, in response to the clock on the processor-side next scale-up second clock line.

24. The scalable bandwidth data interface of claim 23, further comprising:
a memory-side next scale-up first gated clock driver, having an input coupled to the memory-side scale-up first clock line;
a memory-side next scale-up second gated clock driver, having an input coupled to the memory-side scale-up first clock line;
a memory-side next scale-up first clock line, coupled to an output of the memory-side next scale-up first gated clock driver; and
a memory-side next scale-up second clock line, coupled to an output of the memory-side next scale-up second gated clock driver.

25. A scalable bandwidth data interface, comprising:
a processor-side clocked transceiver and a memory-side clocked transceiver that couple, respectively, to a processor side and a memory side of a data lane that extends from a processor to a memory;
a processor-side scale-up clocked transceiver and a memory-side scale-up clocked transceiver that couple, respectively, to a processor side and a memory side of a scale-up data lane that extends from the processor to the memory; and
means for switching from a base mode clocking to a scale-up mode clocking, wherein the means for switching from a base mode clocking to a scale-up mode clocking is configured to include in the base mode clocking a concurrent clocking of the processor-side clocked transceiver and the memory-side clocked transceiver, with disabled clocking of the processor-side clocked transceiver or the memory-side clocked transceiver, and is configured to include, in the scale-up mode clocking, a concurrent clocking of the processor-side scale-up clocked transceiver, the memory-side scale-up clocked transceiver, the processor-side scale-up clocked transceiver and the memory-side scale-up clocked transceiver.

26. The scalable bandwidth data interface of claim 25, further comprising:
a processor-side next scale-up clocked transceiver and a memory-side next scale-up clocked transceiver that couple, respectively, to a processor side and a memory side of a next scale-up data lane that extends from the processor to the memory; and
means for switching from the scale-up mode clocking to a next scale-up mode clocking, wherein the means for switching from the scale-up mode clocking to the next scale-up mode clocking is configured to include in the next scale-up mode clocking a concurrent clocking of the processor-side next scale-up clocked transceiver, the memory-side next scale-up clocked transceiver, the processor-side scale-up clocked transceiver, the memory-side scale-up clocked transceiver, the processor-side scale-up clocked transceiver and the memory-side scale-up clocked transceiver.
